(19) United States
(12) Patent Application Publication
(10) Pub. No.: US 2025/0033762 A1
(43) Pub. Date: Jan. 30, 2025

(54) System and Method for Flight Control Command Source Management (FCCSM)

(71) Applicant: EVE UAM, LLC, Wilmington, DE (US)

(72) Inventors: Filipe Andrade BARUZZI, São José dos Campos – SP (BR); Rafael Desideri DE FREITAS, São José dos Campos – SP (BR)

(21) Appl. No.: 18/775,604

(22) Filed: Jul. 17, 2024

Related U.S. Application Data
(60) Provisional application No. 63/515,231, filed on Jul. 24, 2023.

(51) Int. Cl. G05D 1/22; B64C 29/00; G05D 109/22

(52) U.S. Cl. CPC B64C 13/12; B64C 13/503

(57) ABSTRACT

An eVtol aircraft manages different command inputs from various sources such as multiple inceptor types from the pilot (physical or digital), automatic command from autopilot or autonomous system, voice command, and/or remote piloting from an external source linked to the system. A Flight Control Command Source Management (FCCSM) can manage multiple dissimilar sources of commands for the Flight Control System automatically and based on pilot specified selections and/or a priority list.

### CROSS-REFERENCE TO RELATED APPLICATIONS

Benefit is claimed from U.S. Provisional Patent Application No. 63/515,231 filed 07-24-2023, incorporated herein by reference in its entirety and for all purposes.

### FIELD

This technology relates to aircraft Flight Control Systems (FCS), and to a system and method for managing multiple commands whose destinations are in a Flight Control System (FCS). More specifically, the technical field relates to a Flight Control System for aircraft used in Urban Air Mobility, that is, a Flight Control System for eVtols (Electric Vertical Takeoff and Landing Vehicles).

### BACKGROUND

The state of the art in current aviation field, in certified aircraft, are solutions of pilot commands to the Flight Control System consisting of multiple similar inceptors. For example, on many aircraft, sidestick configurations, columns, pedals are found in pairs for the pilot and co-pilot. Therefore, the command input system for the FCS consists of duplicated similar devices, as for example the ones shown in FIGS. 1 and 1A, consisting of two central columns and two pedals.

However, in vehicles whose pilot operation station is unique and not duplicated, there is no presence of pairs of pilot command devices. In these aircrafts, such as those developed for Urban Air Mobility (eVtols) such as shown in FIG. 8, it is possible that pilot command for the aircraft is used with dissimilar devices. Thus, there is a need for a system and method that can manage multiple dissimilar devices.

### BRIEF DESCRIPTION OF THE DRAWINGS

FIGS. 1 & 1A show prior art examples of command input for a Flight Control System using redundant similar inceptors.

FIG. 2 shows an example of multiple Flight Control System command sources of an eVtol, and comprehends an example of a plurality of dissimilar command sources for a Flight Control System in an electric Vertical Takeoff and Landing (eVTOL) vehicle concept such as shown for example in FIG. 8.

FIG. 3 shows an example of multiple dissimilar inceptors to the Flight Control System in an eVtol, and in particular is an example of dissimilar inceptors being used as command sources for a Flight Control System in an eVtol.

FIG. 4 shows an example Inceptor Calibration function capable of normalizing commands for a Flight Control System, and comprehends an example of inceptor signal modification through the Inceptor Calibration feature of FCCSM.

FIG. 5 is an example Inceptor Calibration functional diagram, and comprehends a functional diagram for the Inceptor Calibration feature of FCCSM.

FIG. 6 is a Command Selection function diagram, and comprehends a functional diagram of the Command Selection feature of the FCCSM.

FIG. 7 is an example of FCCSM components and interfaces.

FIG. 8 shows an example eVtol aircraft of the type with which the present technical can be used.

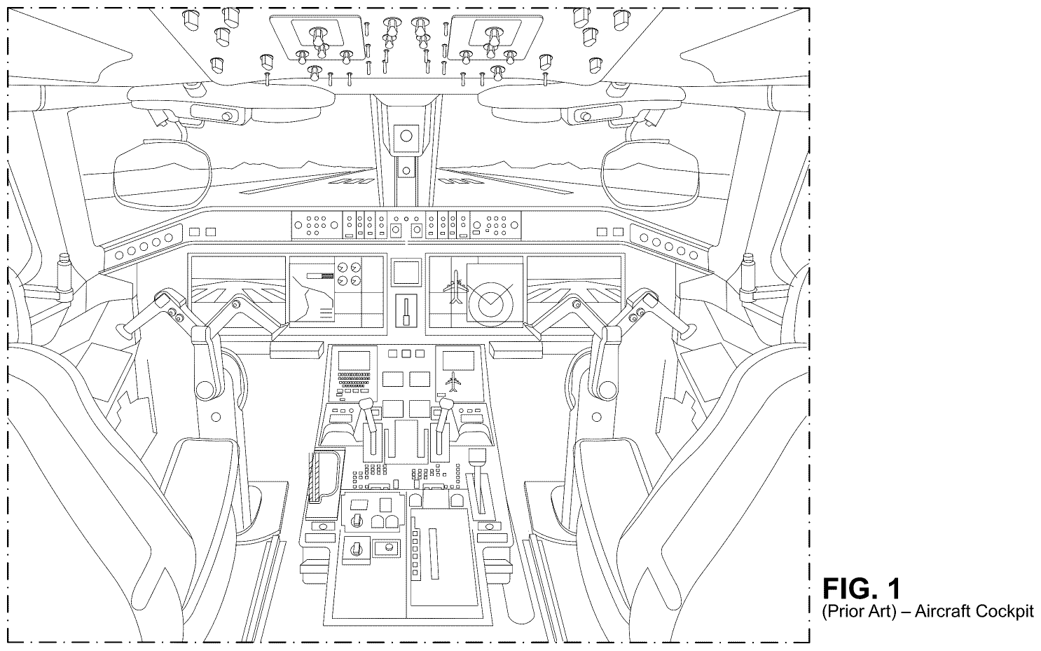

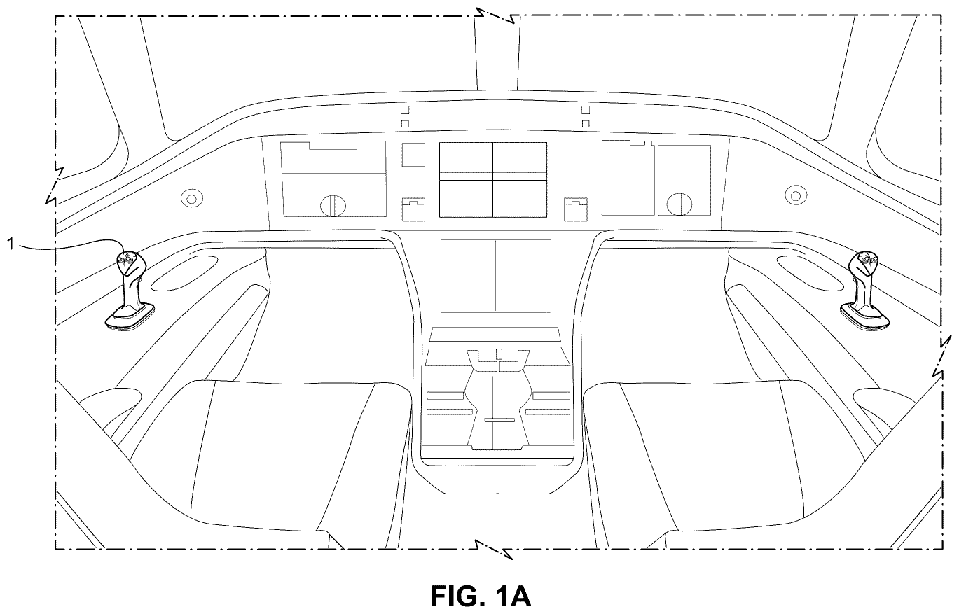

### DETAILED DESCRIPTION OF NON-LIMITING EMBODIMENTS

With the advancement of autonomous technologies, it is possible that input devices to the Flight Control System are or will become even more diverse than those found in current air vehicles.

Therefore, there is a need for the aircraft to be able to manage different command inputs from various sources such as multiple inceptor types from the pilot (physical or digital), automatic command from autopilot or autonomous system, voice command, and even remote piloting from an external source linked to the system.

The technology herein aims to provide systems and methods for Flight Control Command Source Management (FCCSM). Therefore, the aircraft can manage multiple dissimilar sources of commands for the Flight Control System. The following describes example features of non-limiting implementations. These features may be combined with one another in any combination.

In an example embodiment, an eVtol aircraft flight control system comprises input circuitry that receives a first input signal from a first manipulable control device and a second input signal from a second manipulatable control device; conditioning circuitry that processes each of the first input signal and the second input signal to enable either the first input signal or the second input signal to generate eVtol aircraft commands; and a selector circuit that selects between the first input signal and the second input signal for controlling an eVtol aircraft.

The selector circuit selects only one of the first input signal and the second input signal at a time. The conditioning circuitry comprises a normalizing circuit and comprises a dead zone and gain adjusting circuit.

The first manipulable control device is graspable and the second manipulable control device is hand-operable but not graspable.

The generated eVtol aircraft commands comprise a set of commands essential to second-to-second piloting of the eVtol aircraft.

The selector circuit is configured to apply a pilot-specified priority on selecting between the first input signal and the second input signal and/or is configured to automatically detect control device failure and deselect an input signal of a failed control device.

In one embodiment, the first or the second manipulable control device is not on board the eVtol aircraft but may instead be remote from the aircraft and linked via a wireless communications link.

An embodiment of an eVtol aircraft flight control method comprises receiving a first input signal from a first manipulable control device and a second input signal from a second manipulatable control device; processing each of the first input signal and the second input signal to enable either the first input signal or the second input signal to generate eVtol aircraft commands; and selecting between the first input signal and the second input signal for controlling an eVtol aircraft.

Selecting selects only one of the first input signal and the second input signal at a time. Processing comprises normalizing and/or structuring a dead zone and gain.

The first manipulable control device is graspable and the second manipulable control device is hand-operable but not graspable. The generated eVtol aircraft commands comprise a set of commands essential to second-to-second piloting of the eVtol aircraft.

The example method may further include applying a pilot-specified priority for selecting between the first input signal and the second input signal and/or automatically detecting control device failure and deselecting an input signal of a failed control device.

In one embodiment, the first or the second manipulable control device is not on board the eVtol aircraft.

An eVtol aircraft embodiment comprises at least one processor configured to execute instructions from non-transitory memory that control the at least one processor to perform operations comprising: receiving a first input signal from a first manipulable control device, receiving a second input signal from a second manipulatable control device; processing each of the first input signal and the second input signal to enable either the first input signal or the second input signal to generate eVtol aircraft commands; and selecting between the first input signal and the second input signal for controlling the eVtol aircraft.

### Example Flight Control Command Source Management (FCCSM)

The Flight Control Command Source Management (FCCSM) is a system capable of managing multiple inputs, similar or not, to the Flight Control System. In this way, it is possible that continuous management occurs during the operation of the aircraft from the command source to the Flight Control System, which generates, among others, flexibility in the design of the aircraft, as well as can increase the flight safety of the vehicle by monitoring of available command sources.

Inputs to the Flight Control System can be varied, such as: physical devices that transduce pilot movements and/or forces into commands for the aircraft, devices integrated into the Avionics System (for example via touch screen) capable of obtaining pilot commands for vehicle navigation, automatic piloting systems, remote piloting systems, autonomous piloting systems, and voice command, among others.

### Example Possible Input Devices (Command Sources)

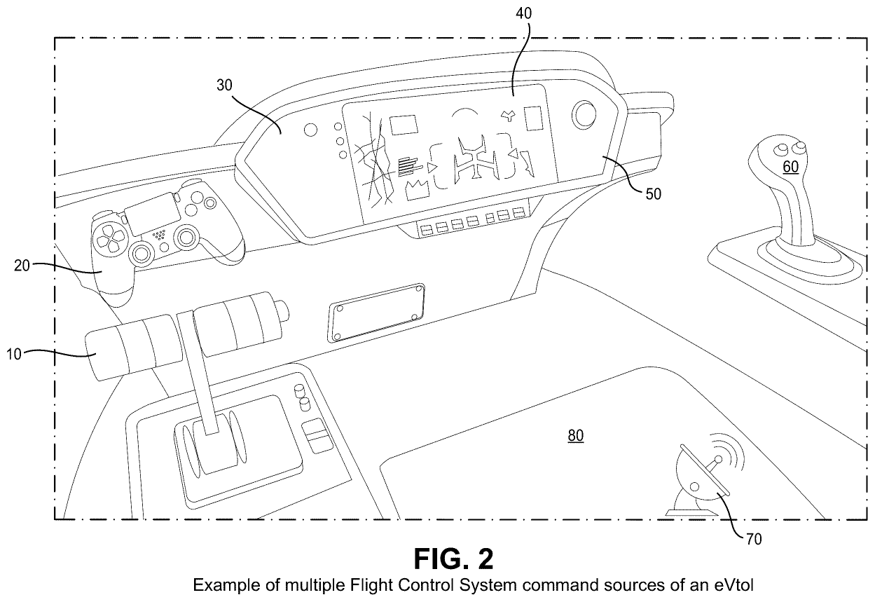

FIG. 2 exemplifies the variety of possibilities of input devices (command sources) to the Flight Control System of an eVtol. In this example, an eVtol cockpit includes a left hand inceptor 10 to the left of a pilot seat 80 configured to be operated by the pilot's left hand, and a right hand inceptor 60 to the right of the pilot seat 80 configured to be operated by the pilot's right hand. In this example, the configuration of the left hand inceptor 10 is different from the configuration of the right hand inceptor 60. For example, the left hand inceptor 10 may be configured to be grasped by one hand and pulled backward toward the pilot or pushed forward away from the pilot in one degree of freedom (rotation). The left hand inceptor 10 may have additional degrees of freedom of movement with various different controls for operation by digits of the pilot's right hand. The pilot can hold with two hands an additional, physical backup inceptor 20 in the form of a common handheld videogame controller, used to control the eVtol in place of inceptors 10, 60. The eVtol further includes an automatic system 30 including a touchscreen backup inceptor 40—in this case a virtual inceptor 40 including graphics displayed on a touchscreen that the pilot can manipulate by touching the touchscreen. The automatic system 30 may further include an autonomous (autopilot) control 50 and a communications link providing for remote control 70 of the eVtol e.g., by a remotely located pilot.

Such eVTOL operation might thus lead to multiple dissimilar inceptors for the Flight Control System. This leads to:
Distinct calibrations for each inceptor; and
A system that's capable of automatically managing the various sources, as well receiving inputs from the pilot for manual FCS source selection.

The example technology herein aims to provide a Flight Control Command Source Management (FCCSM) that is capable to manage multiple sources of commands for the Flight Control System, enabling the selection from different command input sources such as dissimilar inceptors types (physical or digital), automatic command from autopilot or autonomous system, and even remote piloting from an external source linked to the system. The switch between inceptor sources by the FCCSM can be managed by the pilot, or even automatically by the system with indication for the pilots. The Flight Control Laws, and related Flight Control System, are also adapted to be compatible with various sources, receiving already calibrated signals from all sources, being informed by the FCCSM the current active setup for command source.

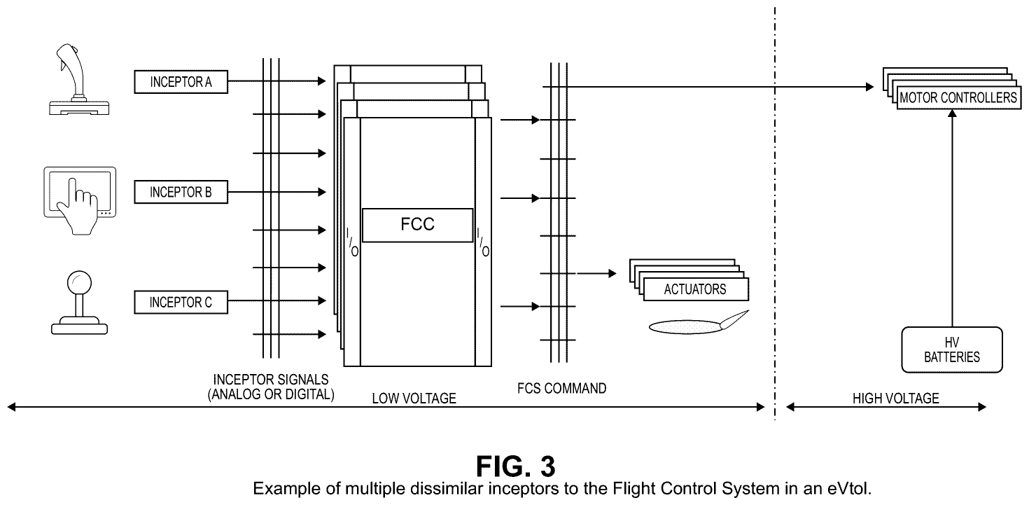

This concept of a plurality of dissimilar inputs for the Flight Control System can be exemplified in an example shown in the FIG. 3 block diagram, in which three dissimilar devices are used as sources of commands to the FCS of an eVtol.

In this example, there is a first “Inceptor A” sidestick-type hand-graspable device, a second “Inceptor B” interactive hand-manipulable (but not hand-graspable) device on a touchscreen display and a third “Inceptor C” hand-graspable device on a joystick, as three independent and distinct, dissimilar command sources. Each of these command sources is a separate, independently controllable device that is “manipulable” by the pilot (e.g., hands and/or feet and/or voice and/or digits) to provide input signals to the FCCSM. In the example shown, the different control devices are intended to each control the same or similar set of essential eVTOL functions such as aircraft heading/rotation, aircraft ascend/descend, aircraft forward speed/change in forward speed, eVtol brake on/off, etc. Thus, in one embodiment, the different control devices are redundant in the sense that each of them can be used without the others to control/pilot the eVtol aircraft. Of course, there may be many other additional cockpit controls the pilot uses to control various aspects of the eVtol aircraft, but in one embodiment, the complete set of essential or key commands related to second-by-second pilot control over taxiing, hovering, and cruising can be generated by each or any of the three hand-manipulable inceptors.

In this example, the FCCSM receives signals from each of these components, monitors their health, selects the device(s) that will provide the command signal(s) for a particular eVtol function, and sends its signal(s) in a normalized and adjusted way (as needed) to the Flight Control System. The Flight Control Command Source Management is hosted in the Flight Control Computer (FCC) in this example, but it may also be hosted in any other hardware such as part of the Avionics System, a standalone processing unit or any processing device.

The communication interface between the inceptors (inceptor A, inceptor B, inceptor C) and the FCCSM application may be of any nature, such as digital or analog, as much as it receives the inceptor's sensor data. Signal readings from inceptors may have unique characteristics due to the possible use of different technologies. The FCCSM is therefore capable of normalizing each or any of the inceptors' data to provide the Flight Control System with a signal having standardized characteristics, regardless of which command source/inceptor is active. Therefore, the signal(s) resulting (output) from the FCCSM has the same relevant technical features, control capabilities and properties for any inceptor in use, to be sent as a command to the Flight Control software.

In one embodiment, the “standardized characteristics” may but need not be standardized in the sense that the signals comply with an IEEE, ISO or other published standard. Rather, “standardized characteristics” in some embodiments may mean that despite differences in their structure, operation and/or function, each of a plurality of inceptors or other input devices produces output control signals that when appropriately conditioned and/or transformed, are compatible with one another, substitutable for one another, and/or replaceable with or for one another, thereby enabling differently-structured input devices to interchangeably control the same (or necessary) eVtol control functions.

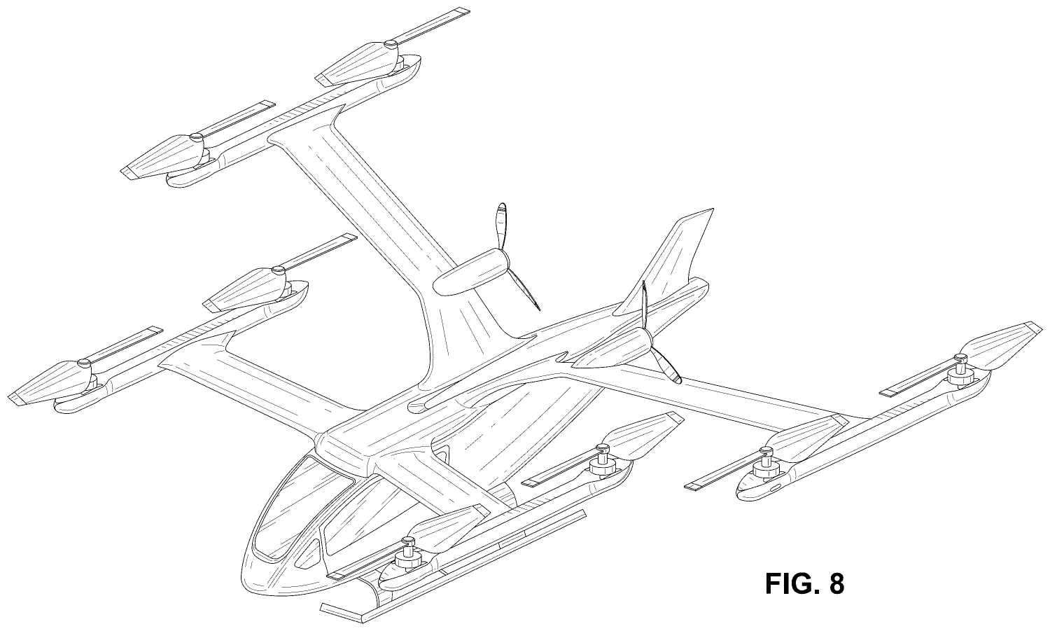

The FCC in turn uses such standardized signal(s) to generate FCS commands to control actuators, motor controllers and other functions which in turn control flight and other operation of the eVtol aircraft such as shown in FIG. 8 (e.g., propeller/motor rotation speed/direction, aircraft pitch/yaw/roll control surfaces, aircraft climb/descent, rudder/steering control surfaces, landing gear retraction/deployment, wheel brakes, aircraft taxiing, etc.). See e.g., Pavel, “Understanding the control characteristics of electric vertical take-off and landing (eVTOL) aircraft for urban air mobility,” Aerospace Science and Technology Volume 125, June 2022, 107143 https://doi.org/10.1016/j.ast.2021.107143.

### Example Normalization and Other Signal Conditioning

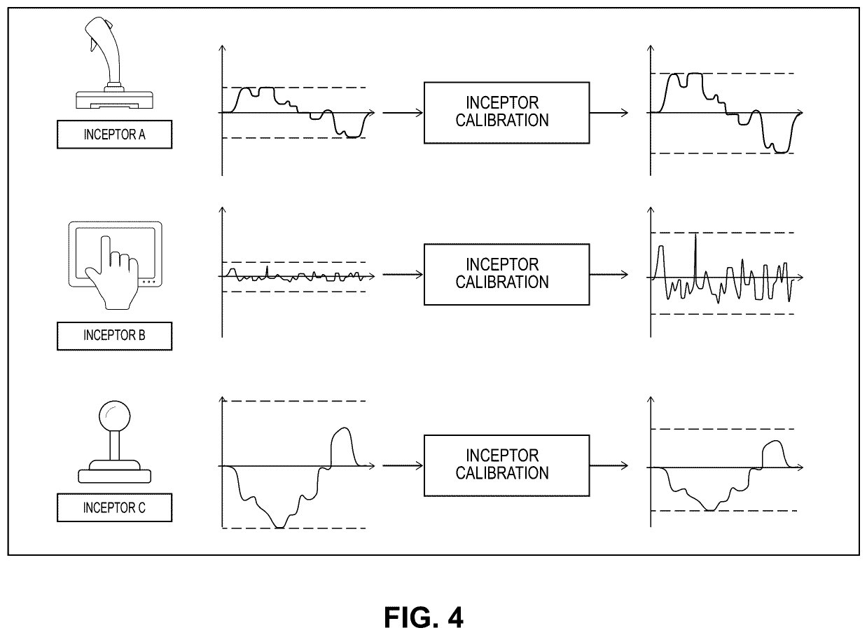

FIG. 4 exemplifies an initial normalization process, performed by the component called Inceptor Calibration, for the example proposed in the previous figure. Briefly, this example initial normalization process is a first step in standardizing the inceptor signals, and is used to calibrate each sensor signal so the amplitude of sensor signal variations is within a desired dynamic amplitude range. Different inceptors may produce different sensor signal amplitude outputs, and this normalization process “fits” the amplitudes within a common dynamic amplitude range.

In more detail, dissimilar or different inceptors may differ in terms of accuracy, precision, sensibility, sensor noise, and other aspects. These differences are treated to avoid spurious or abrupt commands, especially around the zone in which the inceptor is in its neutral position. The Inceptor Calibration function for each inceptor can make changes to the original signal such as dead zone adjustment, change in signal amplitude, as well as gain change (gain adjustment) for different signal ranges associated with a given inceptor, to provide a consistent and/or effective command to the Flight Control System suitable for piloting with that type of inceptor.

As FIG. 4 shows, inceptor calibration for inceptor A applies a positive gain to increase the amplitude range of the inceptor A signal, inceptor calibration for inceptor B applies a (different) positive gain to increase the amplitude range of the inceptor B signal, and calibration for inceptor C applies a negative gain to decrease the amplitude range of the inceptor C signal. In one example embodiment, the resulting normalized dynamic amplitude ranges for the three inceptors A, B, C are the same or close to the same.

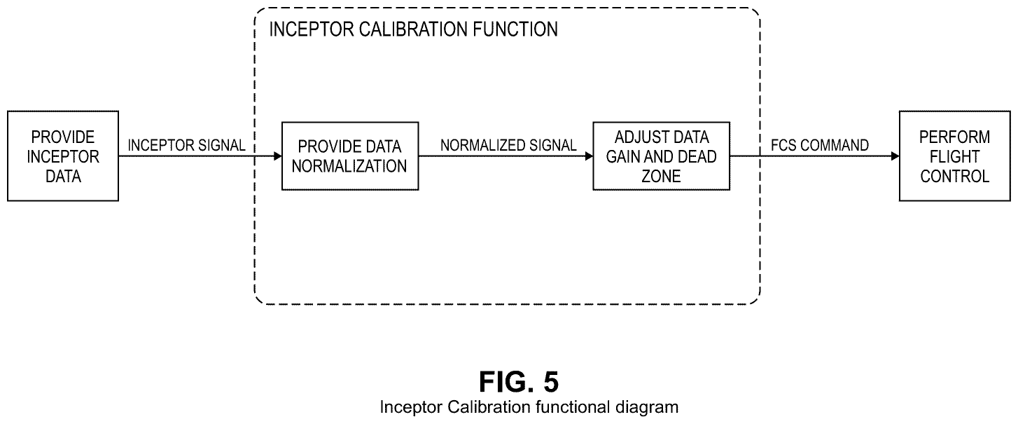

FIG. 5 exemplifies some of the functions present in the Inceptor Calibration. In this example, the amplitude of received inceptor signal is normalized using a variable gain transfer function, and the normalized signal is further modified to provide, eliminate and/or modify dead zones (e.g., such as around neutral positions)—which may or may not be at a zero amplitude (depending on the inceptor). The neutral position(s) of each different inceptor should not be “touchy” (so e.g., a slight unintentional movement away from neutral will cause a large output) but should be responsive (so that a clearly intentional movement away from neutral will generate a desired output). The operation sequence of the functions is not necessarily executed according to this figure and may occur in any order and may be performed by electronic circuits/circuitry and/or digital signal processing and/or a programmed at least one processor. The purpose of the example embodiment Inceptor Calibration is to provide signals from the different inceptors with the same or similar effective characteristics to the Flight Control System, thus allowing dissimilar inceptors to provide data (inceptor signal) with the same or similar effective characteristics to the Flight Control System.

### Example Command Selection

The Command Selector is another element of the Flight Control Command Source Management in example embodiments and has the function of managing multiple command sources for the Flight Control System. This selection can occur manually, through input from the pilot to the system, or automatically, via System Health Monitors, or both. The Command Selector also has interface with Human-Machine Interface (HMI) elements, so that it is possible for the pilot to obtain various feedbacks, such as an indication of the active command source, and warning alerts in case of command source change, or any other system-related information. In an example embodiment, the command selection occurs via the Command Selector function interface with a switch or multiplexer present in the FCCSM, and this selection is performed from a Consolidated Command Selection between the manual and automatic selection of the Command Selector function.

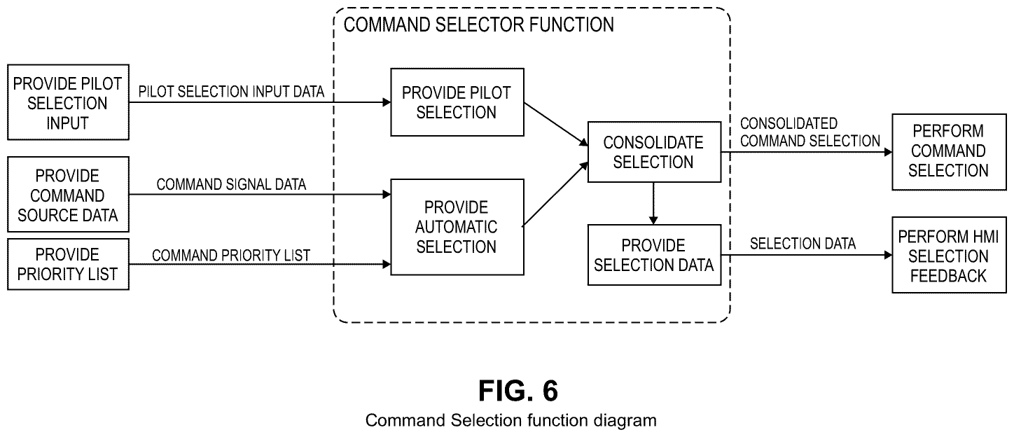

FIG. 6 shows example functional elements of the Command Selector Function. Pilot input to the FCCSM can occur via HMI interfaces, such as an avionics display, or via an element dedicated to this function, such as a selector panel. “Provide Pilot Selection Input function” is where the manual selection of a certain command source from the pilot occurs. “Provide Command Source Data function” transmits signal data from command sources (Command Signal Data) to “Command Selector function”. “Provide Priority List function” transmits the Command Priority List (CPL) to “Command Selector function”. CPL consists of a ranked list for each available command source to be selected/switched in case of automatic selection. It may be predefined in the system, be informed by interfaces with other systems, managed by the pilot or by ground maintenance personnel, or any other variation for defining the CPL.

The example embodiment Command Selector function receives signals from command source devices (Provide Command Source Data function), such as physical inceptors, touch screen avionics, remote station not on board the aircraft that includes a remotely located inceptor operated by a remotely located pilot not on board the aircraft, automatic (i.e., non-human) piloting systems, autonomous system, or any other device with command input to the vehicle. Through Continuous Built-in Tests (CBIT) such elements have their health constantly monitored via System Health Monitors (embedded into the “Provide Automatic Selection function”), so that if one of the sources is declared (detected) as failed, it is automatically eliminated (deselected) from the selection list of commands available for the pilots in the CPL and a warning to the pilot is automatically generated. For the Automatic Selection, when there is a need to switch the command source, this change occurs via a circular buffer in which the source that was in control becomes the last in the priority list for the FCCSM. Pilot selection has priority over automatic selection. This occurs in “Consolidate Selection function”, in which case the pilot wishes to use a source different from the one specified in the automatic selection, the manual selection of the “Provide Pilot Selection function” has greater authority over the “Provide Automatic Selection function” (different pilots can have different selection preferences). The “Consolidate Selection function” output is used for selecting between/switching command sources for the Flight Control System, as well as for providing feedback to the pilot on HMI elements. Such selecting/switching can be performed for example by digital logic such as multiplexers, by analog switches, or by digital processors that receive, process, condition, test and/or synthesize control signals and/or by one or more processors executing instructions stored in memory. Selection algorithms for instances in which multiple inceptor inputs can be valid but are not totally consistent with one another can be rule-based and/or empirical-based. Selection between plural controllers each of which are concurrently active may occur in a predictable way with adequate feedback to the pilot.

Flight Control Command Source Management allows aircraft to use dissimilar inceptors and facilitates switching between these inceptors for the Flight Control System. The FCCSM in an embodiment provides continuous feedback on the selection to the pilot, as well as allowing the operator to intervene for the desired command source if chosen. The FCCSM can be integrated into Flight Control Computers, or can be in any device that has an interface with the Flight Control System. FCCSM consolidation may occur in case multiple instances of this system are running in parallel, with functions being shared across the multiple instances.

### Example End to End System and Method

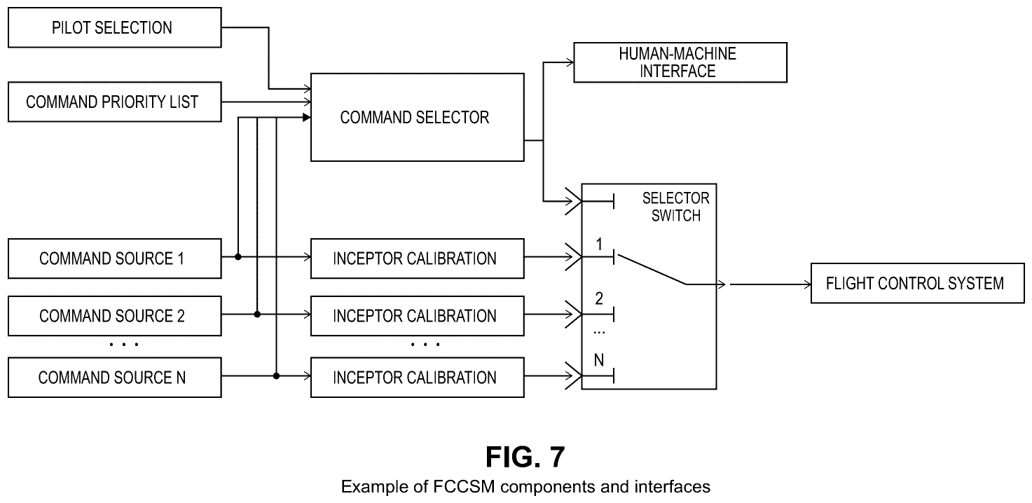

FIG. 7 is a block diagram showing an end to end system including pilot inputs of the types described above (selection, command priority, command sources 1-N), a command selector that analyzes those various inputs to provide a command selector control controlling a command source selector switch or multiplexer to send a selected normalized command source signal to the FCS, and a HMI that indicates to the pilot which command source has been selected. In one embodiment, the command selector selects at any given time, commands generated in accordance with input signals provided by only one pilot inceptor device (i.e., there is no mixing or “fusing” of input signals to generate aircraft command signals), but the command selector can at any time change from commands generated from one inceptor's input signals to commands generated from another inceptor's input signals. Thus, the system shown could allow the pilot to use one inceptor for a first phase of eVtol aircraft flight (e.g., taxiing), another inceptor for a second phase of eVtol aircraft flight (e.g., hover), a third inceptor for a third phase of eVtol aircraft flight (e.g., cruising), and so on. Or, the system could automatically sense that the pilot has put down or stopped holding or manipulating a first inceptor and picked up or started holding or manipulating a second inceptor, and react by ceasing to generate commands based on the first inceptor and beginning to generate commands based on the second inceptor. Maximal flexibility is provided to the pilot so the pilot can effectively pilot the eVtol aircraft in whatever way the particular pilot thinks best (different pilots can have different preferences without consistent overall safety considerations and training).

This example system thus allows viewing the different elements of the FCCSM for different command sources, with “N” being the appropriate number of sources for a given aeronautical project. The command selector may analyze normalized or not-yet-normalized command source signals, and may make selections based on which command sources are providing active outputs (or in the case multiple ones are providing active outputs, based on the priority list and/or pilot selection). Digital logic and/or at least one processor executing instructions stored in non-transitory memory may operate as the command selector.

All patents and publications cited herein are incorporated by reference as if expressly set forth.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. An eVtol aircraft flight control system comprising:
input circuitry that receives a first input signal from a first manipulable control device and a second input signal from a second manipulatable control device;
conditioning circuitry that processes each of the first input signal and the second input signal to enable either the first input signal or the second input signal to generate eVtol aircraft commands; and
a selector circuit that selects between the first input signal and the second input signal for controlling an eVtol aircraft.

2. The eVtol aircraft flight control system as in claim 1 wherein the selector circuit selects only one of the first input signal and the second input signal at a time.

3. The eVtol aircraft flight control system as in claim 1 wherein the conditioning circuitry comprises a normalizing circuit.

4. The eVtol aircraft flight control system as in claim 1 wherein the conditioning circuitry comprises a dead zone and gain adjusting circuit.

5. The eVtol aircraft flight control system as in claim 1 wherein the first manipulable control device is graspable and the second manipulable control device is hand-operable but not graspable.

6. The eVtol aircraft flight control system as in claim 1 wherein the generated eVtol aircraft commands comprise a set of commands essential to second-to-second piloting of the eVtol aircraft.

7. The eVtol aircraft flight control system as in claim 1 wherein the selector circuit is configured to apply a pilot-specified priority on selecting between the first input signal and the second input signal.

8. The eVtol aircraft flight control system as in claim 1 wherein the selector circuit is configured to automatically detect control device failure and deselect an input signal of a failed control device.

9. The eVtol aircraft flight control system as in claim 1 wherein the first or the second manipulable control device is not on board the eVtol aircraft.

10. An eVtol aircraft flight control method comprising:
receiving a first input signal from a first manipulable control device and a second input signal from a second manipulatable control device;
processing each of the first input signal and the second input signal to enable either the first input signal or the second input signal to generate eVtol aircraft commands; and
selecting between the first input signal and the second input signal for controlling an eVtol aircraft.

11. The eVtol aircraft flight control method as in claim 10 wherein selecting selects only one of the first input signal and the second input signal at a time.

12. The eVtol aircraft flight control method as in claim 10 wherein processing comprises normalizing.

13. The eVtol aircraft flight control method as in claim 10 wherein the processing comprises structuring a dead zone and gain.

14. The eVtol aircraft flight control method as in claim 10 wherein the first manipulable control device is graspable and the second manipulable control device is hand-operable but not graspable.

15. The eVtol aircraft flight control method as in claim 10 wherein the generated eVtol aircraft commands comprise a set of commands essential to second-to-second piloting of the eVtol aircraft.

16. The eVtol aircraft flight control method as in claim 10 further including applying a pilot-specified priority for selecting between the first input signal and the second input signal.

17. The eVtol aircraft flight control method as in claim 10 further including automatically detecting control device failure and deselecting an input signal of a failed control device.

18. The eVtol aircraft flight control method as in claim 10 wherein the first or the second manipulable control device is not on board the eVtol aircraft.

19. An eVtol aircraft comprising at least one processor configured to execute instructions from non-transitory memory that control the at least one processor to perform operations comprising:
receiving a first input signal from a first manipulable control device,
receiving a second input signal from a second manipulatable control device;
processing each of the first input signal and the second input signal to enable either the first input signal or the second input signal to generate eVtol aircraft commands; and
selecting between the first input signal and the second input signal for controlling the eVtol aircraft.
